(19) United States
(12) Patent Application Publication
(10) Pub. No.: US 2015/0358505 A1
(43) Pub. Date: Dec. 10, 2015

(54) Imaging Device-Based User Authentication System and Methods

(71) Applicant: Lexmark International, Inc., Lexington, KY (US)

(72) Inventors: Reannette Heart Lepalam Diaz, Cebu City (PH); John Henry Kimmon, Lexington, KY (US); Theresa Leah Edillon Laurito, Fairfield, IA (US); Rossveth Niere Lopez, Cebu (PH); Jervie David Bernal Montejar, Cebu City (PH); Neilvert Noval, Cebu City (PH); Denmark Recto Parcon, Cebu City (PH); Kirstin Jamero Santiago, Cebu City (PH); Darwin Corpus Tiu, Cebu (PH); Charles Carin Torrejos, Cebu (PH); Mark Edward Vance, JR., Lexington, KY (US)

(21) Appl. No.: 14/514,550

(22) Filed: Oct. 15, 2014

Related U.S. Application Data
(60) Provisional application No. 62/008,664, filed on Jun. 6, 2014.

(51) Int. Cl. H04N 1/44; H04N 1/32; H04N 1/00; G06K 15/00; G06F 3/12

(52) U.S. Cl. CPC H04N 1/4413; G06K 15/4095; G06F 3/1222; G06F 3/1238; H04N 1/00856; H04N 1/00209; H04N 1/32101; H04N 2201/0094

(57) ABSTRACT

A method for authenticating a user for operating at least one imaging device from a network of imaging devices without using an authentication server is disclosed. The method includes configuring a first imaging device from the network to store a registry of users authorized to access the imaging device. Another imaging device from the network receives log-in information from the user which is sent to the first imaging device for authentication. If the log-in information is authenticated at the first imaging device, the user is provided access to one or more functions of the imaging device.

### FIELD OF THE INVENTION

The present invention relates to authenticating a user for operating an imaging device. More particularly, it relates to authenticating a user for accessing an imaging device without the use of an authentication server.

### BACKGROUND

In a printing system environment having one or more imaging devices, operations of an imaging device or a multi-function product (MFP) may be restricted from a user until the user authenticates using a badge, or a username/password combination, and the like. An imaging device typically receives user information and sends the information to a server to authenticate the user prior to allowing the user access to functions of the imaging device. If the user authentication is successful, the user is then allowed to execute one or more functions in the imaging device such as printing, scanning and copying, among others. The authentication process in this type of networked environment is typically performed using a dedicated authentication server connected to the one or more imaging devices. The dedicated authentication server is also used to store and manage user credentials, such as user identifiers and access controls for each user identifier, in a registry.

Alternatively, an active directory may be used to authenticate users in a network of imaging devices. An active directory is a type of lightweight directory access protocol (LDAP) directory service that is conventionally used in a Windows operating system environment and provides authentication and authorization services to computers. The active directory is also typically used to add new user information to the registry when the user logs into the imaging device using a badge, a username and password combination, and the like.

In small offices that require a relatively small network of imaging devices to operate, setting up a dedicated authentication server and/or an active directory to manage the user authentication process is an added cost. The overhead costs that may be incurred in the maintenance and operation of the main authentication server, and additionally, of a backup authentication server, may also add up over time.

Accordingly, a need exists in the art for systems and methods of authenticating a user of an imaging device without the use of a dedicated authentication server and/or of badge-ready active directories. Additional benefits and alternatives are also sought when devising solutions.

### SUMMARY

The above-mentioned and other problems are solved by systems and methods for authenticating a user for operating one of the imaging devices from the network without using an authentication server. The method includes configuring a first imaging device from the network of imaging devices to store a registry of users authorized to access the imaging device. Log-in information is then received from the user at a second imaging device connected to the first imaging device. Log-in information may be badge information received at the imaging device through a badge reader, and the like. The second imaging device then sends the received log-in information to the first imaging device for authentication. The first imaging device determines if the log-in information corresponds to an authorized user using a registry in first imaging device, and sends the result of the determining to the second imaging device. If the result of the determining indicates that the log-in information corresponds to the authorized user in the registry, the second imaging device provides the user access to one or more functions of the second imaging device.

These and other example embodiments are set forth in the description below. Their advantages and features will become readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 shows an example system for authenticating a user in a network of imaging devices.

FIG. 2 shows an example embodiment of a method of configuring roles in the imaging devices connected to the network.

FIG. 3 shows one example embodiment of a method of receiving badge validation request at master imaging device from client imaging device.

FIG. 4 shows one example embodiment of a method of receiving badge information from a user and enrolling the badge using the example system.

FIG. 5 shows another example method of authenticating a user for operating an imaging device in the network of imaging devices using the example system.

FIG. 6 is an example system and method for managing changes in the imaging device configured to be the master imaging device in the network.

FIG. 7 shows an example method of updating a master imaging device and one or more registered client imaging device in the network when a change in the network identifier of backup imaging device is detected.

FIG. 8 shows an example system and method for updating the master imaging device and backup imaging device when a change in the network information of client imaging device is detected.

FIG. 9 shows one example embodiment of master imaging device receiving one or more requests for registering a backup imaging device and/or one or more client imaging devices to the system.

### DETAILED DESCRIPTION OF THE ILLUSTRATED EMBODIMENTS

In the following detailed description, reference is made to the accompanying drawings where like numerals represent like details. The example embodiments are described in sufficient detail to enable those skilled in the art to practice the invention. It is to be understood that other example embodiments may be utilized and that process, electrical, and mechanical changes, etc., may be made without departing from the scope of the disclosure. The following detailed description, therefore, is not to be taken in a limiting sense and the scope of the invention is defined only by the appended claims and their equivalents. In accordance with the features of the disclosure, systems and methods for authenticating a user for operating one of the imaging devices from the network without using an authentication server, the method including configuring a first imaging device from the network of imaging devices to store a registry of users authorized to access the imaging device; receiving log-in information from the user at the imaging device; sending the log-in information from the imaging device to the first imaging device for determining if the log-in information corresponds to an authorized user in the registry; receiving a result of the determining if the log-in information corresponds to the authorized user in the registry; and if the result of the determining indicates that the log-in information corresponds to the authorized user in the registry, providing the user access to one or more functions of the imaging device.

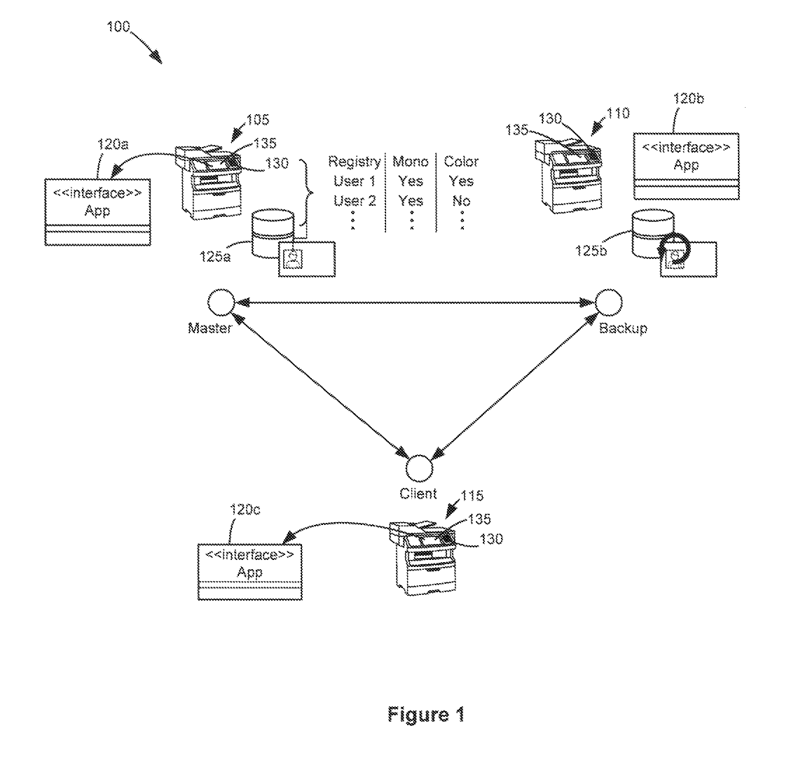

With reference to FIG. 1, there is shown a system 100 including a first imaging device 105, a second imaging device 110, and a third imaging device 115. Imaging devices 105, 110 and 115 are connected to each other via one or more communication links in a network such as, a local area network (LAN). Each of the imaging devices 105-115 are installed with an application 120 that enables each of the imaging device to perform a role in the authentication of a user prior to allowing the user access to any imaging device in the network of imaging devices.

Imaging devices 105-115 are devices capable of printing or producing a hard copy corresponding to a data file or document stored in electronic form, such as a laser, inkjet or dot matrix printer or multi-function product that has the capability of performing other functions, such as faxing, e-mailing, scanning and/or copying, in addition to printing, as will be known in the art.

A badge reading device 130 may also be communicatively connected to each of imaging devices 105-115 for receiving badge information using a security identification badge, and the like. In one alternative example embodiment, imaging devices 105-115 each includes a user interface 135 such as, for example, a touch screen application that prompts a user of imaging device to enter an input corresponding to a user credentials, or any other information that may be used by imaging device to authenticate a user prior to giving the user access to one or more functions of the imaging device. Imaging devices 105-115 may also include a network interface for sending data such as the user credentials to other devices communicatively connected with imaging devices 105-115 in the network.

Each of the example imaging devices 105-115 is installed with an application 120 that configures the imaging devices to each perform a role in providing one or more users secure access to any of the imaging devices in the network. Application 120a may be installed on imaging device 105 to configure imaging device 105 to act as an authentication server that may be used by other imaging devices connected to imaging device 105 in authenticating users. In this example embodiment, imaging device 105 installed with application 120a will also be referred to herein as master imaging device 105 and application 120a as a function access control (FAC) application within a security framework of master imaging device 105. Installing FAC application 120a configures imaging device 105 to become a master imaging device by storing in a memory of imaging device 105 a registry 125a of one or more users that are allowed access to the imaging devices communicatively connected with imaging device 105. The FAC application 120a uses registry 125a to authenticate users of the imaging device prior to providing the users access to one or more FAC-restricted functions of the imaging device. For example, if printing in imaging device 105 is set as a FAC-restricted function such that not all users are given permission to execute the printing in imaging device 105, FAC application 120a will request user to swipe a badge ID using badge reading device 130, and will authenticate the badge information prior to giving access to the requested function. In an alternative example embodiment, FAC application 120a may request user to enter user credentials prior to giving the user access to imaging device 105.

Imaging device 110 is installed with FAC application 120b that configures imaging device 110 to be a backup imaging device that stores a copy registry 125b containing users similar to those stored registry 125a in master imaging device 105. Typically, registries 125a and 125b stored in imaging devices 105 and 110 are the same unless changes are made in at least one of imaging devices 105 and 110. If changes are made in at least one of the registries stored in imaging device 105 and 110, a sync process may be performed to ensure that the data between the registry in master imaging device 105 and backup imaging device 110 are consistent. The sync process may be performed automatically when connected between master imaging device 105 and backup imaging device 110 is established and/or right after a change in the any one of the registries is detected. In an alternative example embodiment, the syncing may be performed at a predefined schedule.

If one of the master imaging device 105 and backup imaging device 110 is in a downtime condition such as, for example, when the master imaging device 105 is disconnected from the network of imaging devices, backup imaging device 110 may take on the role of the master imaging device 105 temporarily until master imaging device 105 reconnects successfully to the network. When a change occurs in the data in registry 125b of backup imaging device 110, the syncing of the data may be performed automatically upon reconnection of master imaging device 105 to the network. While the other device is down, the active imaging device which, for illustrative purposes, is backup imaging device 110 creates a temporary file that stores the changes that occurred in registry 125b that have not been synced to the device in downtime condition such as, in this example, the master imaging device 105. For example, while master imaging device 105 is down, backup imaging device 110 stores badge information updates entered on registry 125b on the temporary file and when master imaging device 105 reconnects to the network, the syncing process may begin using the data stored on the temporary file as reference for syncing new data from registry 125b of backup imaging device 115 to registry 125a of master imaging device 105.

Imaging device 115 is installed with FAC application 120c that configures imaging device 115 to be a client imaging device that provides users secure access to imaging device 115 through an authentication process that occurs using at least one of master imaging device 105 and backup imaging device 110. Imaging device 115 may also be referred to herein as client imaging device 115. Application 120c installed in imaging device 115 may be used to configure imaging device 115 to communicate with the configured master imaging device 105 in the network. Application 120c is used to specify that client imaging device 115, and any other imaging device in the network that has been set up as a client imaging device, contact an IP address of master imaging device 105 for user authentication. Imaging device 115, and any other configured client imaging devices in the network, may be configured to access backup imaging device 110 when the client imaging devices are not able to communicate with the master device.

Master imaging device 105 may be the first device that another imaging device in the network communicates with to authenticate a user. Master imaging device 105 is the primary device that is typically first used to store information regarding the user registry 125a. Master imaging device 105 acts as the master of user registry 125a and/or authentication information control while backup imaging device 110 is the secondary server that periodically copies the information stored at master imaging device 105. If master imaging device 105 is offline such that an imaging device in the network is not able to communicate with master imaging device 105 for authenticating users, backup imaging device 110 will be communicated to perform the authentication process using registry 125b instead.

FAC application 120 is an application that is installed in the imaging devices in the network for use in setting up a role for each of the imaging devices installed with application 120. As discussed above, the role may refer to a role of the imaging device in method of authenticating a user such as, for example, a master imaging device, a backup imaging device, and a client imaging device.

FAC application 120 may be configured to support at least two authorities by which users can be authenticated in order to register a badge ID such as, for example, an LDAP or active directory, and internal accounts. FAC application 120 may be configured to use address book for LDAP. In another example embodiment, FAC application 120 may be installed in an imaging device to operate with a self-contained badge registry that is automatically created and managed. Maintaining a self-contained badge registry in the imaging device eliminates the need for a separate stand-alone database for badge registration or for users to alter the active directory. The self-contained registry may be able to service a single device or a group of imaging devices and may be able to support a predefined number of users for the group of imaging devices.

FAC application 120 may be used to configure settings in the authentication process such as, for example, specifying the login information and/or log-in method to be used by a user to log in to an imaging device (e.g. card login, or manual login). When FAC application 120 is used to set up the roles of the imaging devices in the network, an administrator may require the network to have a master imaging device, a backup imaging device, and one or more client imaging devices registered to the configured master and backup imaging devices. Other settings that may be set using FAC application 120 includes specifying a backup imaging device when the master imaging device 105 has at least one registered client imaging device; and configuring registered client imaging devices to have a master imaging device and a backup imaging device. Configuring the imaging devices in the network to communicate with the corresponding imaging device may include retrieving or determining an IP address, host name, MAC address, or any network identifier of the imaging devices, and configuring the imaging device to communicate with the corresponding network identifiers during the authentication process. Other network identifiers that can be used to communicate with the master and backup imaging devices will be known by skilled artisans.

FAC application 120 may also be used to access the status of one or more imaging devices in the network. Status information may include the connectivity status of the imaging devices; uptime information of the imaging device and the application such as, for example, duration of FAC application 120 running in the imaging device; the last activity of the imaging device; the total number of registered users in registry 125; the last sync of master imaging device with the backup imaging device, and vice-versa; the last activity of the imaging device performing a function of its role (e.g. the last activity of the backup imaging device functioning as a master imaging device); duration of backup imaging device 110 functioning as the temporary master imaging device while master imaging device 105 is down; and other status information as will be known in the art.

FAC application 120 may also be used to manage client imaging devices such as, for example, adding or registering client imaging devices using a network identifier (e.g. IP address) of the imaging device; and deleting registered client imaging devices in the network. FAC application 120 may also be used to change roles of the imaging devices in the network such as, for example, reconfiguring an imaging device to become a master imaging device instead of a backup imaging device, or to configure a client imaging device to become the master or backup imaging device in the network, and the like.

In an alternative example embodiment, FAC application 120 may use web service to communicate between the imaging devices in the network. The web service may be installed in the imaging devices. The web service architecture is a software function that is provided at a network address over the network and may be used to support interoperable interface of the imaging devices in the network.

Registry 125 refers to a system-defined collection of data including one or more users that are allowed access to at least one imaging device in the network of imaging devices. The users may be registered users in the network. A user may be registered to the network when it has user credentials registered in the internal accounts system or in the active directory, and the user credentials have been paired with a badge ID. Registry 125 may also include client imaging devices in the network that have been registered to communicate with one of master imaging device 105 and backup imaging device 110 for authenticating users. Client imaging devices may register to master imaging device 105 and backup imaging device 110 using FAC application 120 where the client imaging devices are configured to communicate with the network information of master imaging device 105 and backup imaging device 110 when authenticating users. Master imaging device 105 and backup imaging device 110 may then add the network information of the registered client imaging devices in their respective registries.

In one example embodiment, registry 125 allows an administrator of the network to define the users who are allowed to access the imaging devices in the network, as well as the functions in imaging devices using user credentials such as an account name and/or a user ID paired with a badge ID. The administrator may modify registry 125 such as, for example, add new users, delete an existing user, and modify the permissions of the user to operate a function in an imaging device in a network. For example, the administrator may restrict a user from performing colored printing, or scanning and e-mailing on a particular imaging device.

In an alternative example embodiment, registry 125 may also store temporary badge accounts. Temporary badge accounts refer to user accounts that expire at a given period of time. For example, some users may be given temporary access to imaging devices on a network and may require a different type of badge account from the users that are given a longer and/or permanent access to the imaging devices on the network, or FAC-restricted functions in the imaging devices. In another alternative example embodiment, in the event a user attempts to register a second badge, FAC application 120 in imaging device may prompt user and ask if the badge swiped is a temporary badge. If the user responds positively, the badge may be registered for a configurable period of time such as, for example, 24-48 hours. After the configured time period, the temporary badge ID may be de-authorized and the user may be required to revert back to the original badge ID in stored in registry. If the user responds negatively, the user's existing badge ID may be replaced with the new badge ID.

In one example embodiment, data stored in registry 125 may be imported and/or exported. Exporting and importing data may be performed when the registry of one of master and backup imaging devices 105 and 110, respectively, needs to be updated such as, for example, when registry data needs to be added and/or removed. Importing and exporting data may also be used for populating the registries with multiple user accounts. Exporting and importing of registry data may also be used for setting up another set of devices with the same user registry.

The export of data in registry 125 may be performed as an automated process wherein output of data sets within the registry 125 is requested using user interface 135 of one of master and backup imaging devices 105 and 110, respectively, and the data is then made available for saving and/or using by another software application, or for importing to another device such as, for example, exporting data in registry 125a of master imaging device 105 to be used in backup imaging device 110. In one example embodiment, the data to be exported may be translated from one format used on one application into another format to be used by another application. For example, the data may be parsed to a format readable to end users. The translation process may be performed using one or more machine processes such as, for example, data transformation, transcoding, parsing, and other data conversion or translation processes as will be known in the art. Data from registry 125, or from other sources may also be imported to registries 125a and 125b. Importing the data may include adding entries to a list, or by inserting data records to a database. The importing of data may vary based on the format of registries 125a and 125b. Other methods of importing data to a registry will be known in the art.

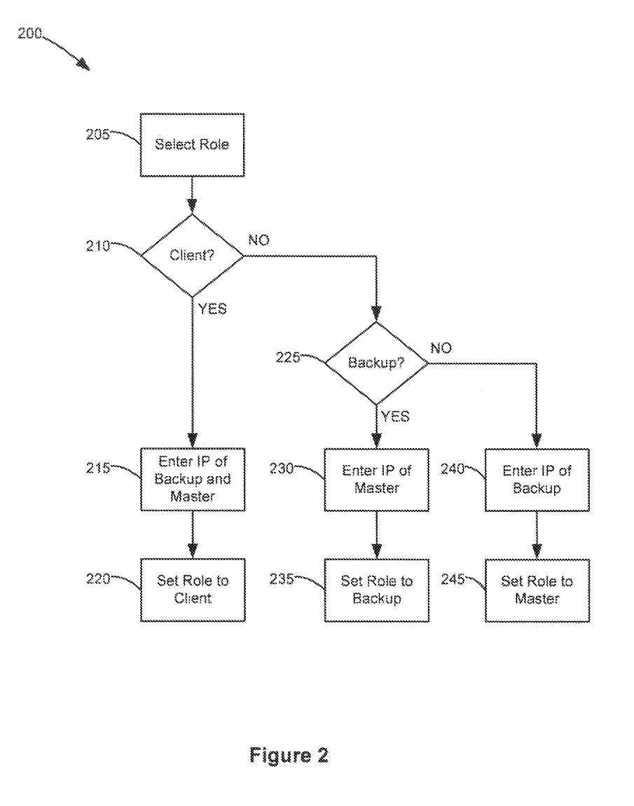

FIG. 2 shows an example embodiment of a method 200 of configuring roles in the imaging devices connected to the network. At 205, a role may be selected for an imaging device in the network. The data is entered using FAC application, or any application installed in the imaging device to be configured.

If at 210, if the imaging device is configured to be a client imaging device, the network identifiers of the configured master imaging device 105 and the backup imaging device 110 may be entered in FAC application 120 of the configured client imaging device 115 (at 215) and the imaging device's role is then set to client (at 220). A typical network identifier for the imaging devices in the network includes the IP address of the imaging devices, but other types of network identifier will be known by skilled artisans.

At 225, the imaging device is configured to be a backup imaging device 110, the network identifier of master imaging device 105 is associated with the configured backup imaging device (at 230) and the imaging device's role will then be set to backup imaging device (at 235).

At 225, if the imaging device is not configured to be any one of client imaging device and backup imaging device, the imaging device is configured as a master imaging device and the network identifier of the configured backup imaging device is entered and associated with the imaging device (at 240). The imaging device's role in the network is then set to master imaging device 105 (at 245).

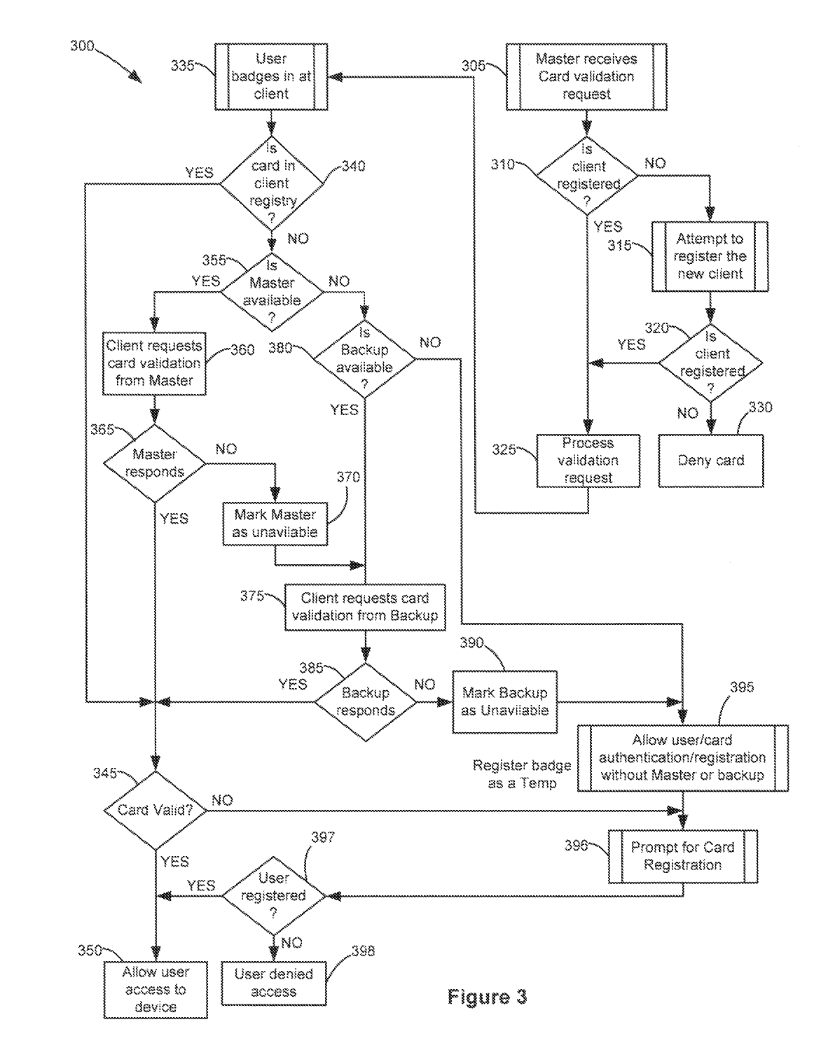

FIG. 3 shows one example embodiment of a method 300 of receiving badge validation request at master imaging device 105 from client imaging device 110. At 305, master imaging device 105 receives card validation request from client imaging device 115.

At 310, it is determined if the requesting client imaging device is registered in master imaging device 105. The client imaging device 115 is registered in master imaging device 105 if the network identifier of the requesting client imaging device 115 is in the list of registered client imaging devices for master imaging device 105.

If at 310 the requesting client imaging device is determined to be unregistered, an attempt to register the new client imaging device 115 is initiated (at 315) and once the registration is successful, the badge validation request of the client imaging device 115 is then processed (425). If the registration is not successful, the badge for which validated is requested is denied (at 330) and a notification may be sent to the requesting client imaging device 115 indicating that the client imaging device must be registered to master imaging device 105 prior to processing the badge validation request.

At 335, user badges in at client imaging device 115 using badge and at 340, it is determined if the badge is in client registry (at 340). Client registry may be a registry of users stored in client imaging device 115 and contains one or more users authorized to access client imaging device 115. If badge registry is in client registry and is considered valid (at 345), the user is then allowed to access client imaging device 115 (at 350). If at 340, the badge is not listed on the client registry, client imaging device 115 may ping master imaging device 105 for availability (at 355). If master imaging device 105 is available, client imaging device 115 requests badge validation from master imaging device 105 (at 360) by sending the badge information to master imaging device and master imaging device 105 responds whether the badge is valid for granting the user access to client imaging device 115 (at 365). If master imaging device 105 determines that the badge is valid, the user is then allowed access to device (at 350). If at 365, master imaging device 105 fails to respond about the validity of the badge, master imaging device 105 is marked as unavailable (at 370) and client imaging device 115 requests badge validation from backup imaging device 115 instead (at 375).

If at 355, master imaging device 105 is not available for processing the badge validation, client imaging device 115 sends a query to determine if backup imaging device 115 is available to process the badge validation request (at 380), and if the query returns a positive determination, client imaging device 115 requests for badge validation from backup imaging device 115 (at 375). Requesting badge validation from backup imaging device 115 includes sending the badge information received at client imaging device 115 to backup imaging device 110.

At 385, backup imaging device 110 determines if the received badge information is a valid badge for granting user access to client imaging device and responds with a result of the determination. If the response returns a positive determination (at 345), the user is then allowed access to client imaging device. If backup imaging device 110 fails to return a response, backup imaging device may be marked as unavailable (at 390), and user and badge registration is then allowed on client imaging device 115 without the use of one of master and backup imaging device 105 and 110, respectively (at 395). User registration may be initiated at client imaging device and if user is successfully registered (at 397), user may be allowed access to client imaging device 115 (at 350). If the user registration is unsuccessful such that user is determined to have no rights for access client imaging device 115, user may be denied access to the device (at 398). Successful user and badge registration may be determined by requesting user credentials from the user and authenticating the user credentials using an internal accounts system or through an active directory, as will be known in the art.

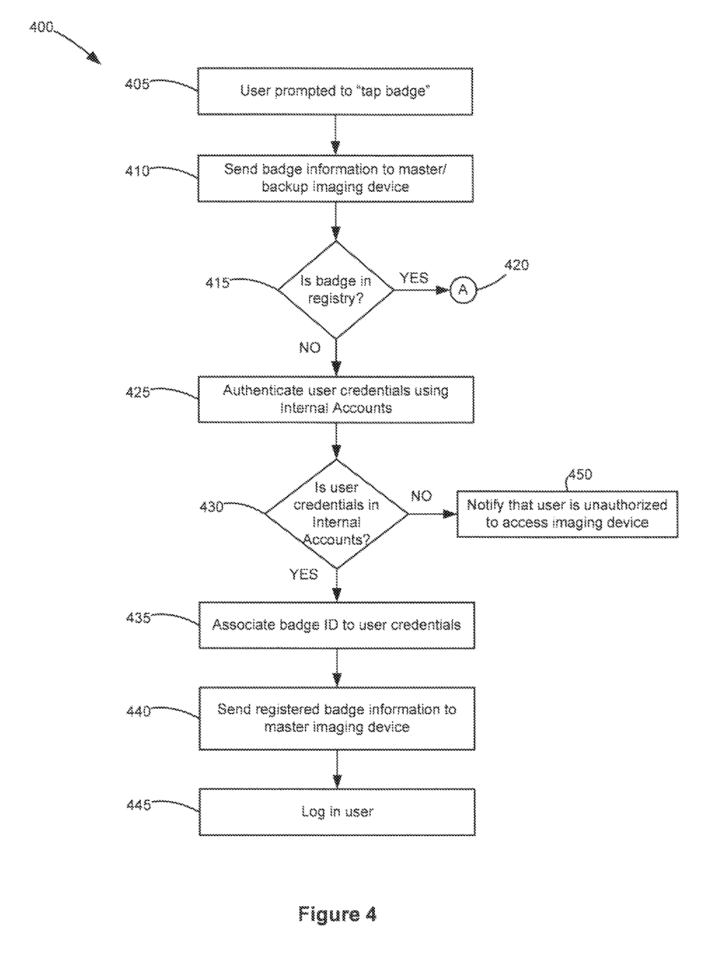

FIG. 4 shows one example embodiment of a method 400 of receiving badge information from a user and enrolling the badge using the example system 100. Enrolling a badge may be performed when the imaging device identifies that the badge entered by the user has not been previously enrolled such as, for example, when a user is using the badge to access the imaging device for the first time. It will be understood that any of the imaging devices in the network installed with FAC application 120 is able to perform method 400.

At 405, the user may be prompted to enter badge information such as, for example, swiping the badge on a badge reading device 130 installed in an imaging device connected to the network. The badge information may be prompted when the user attempts to access the device and/or a feature in the imaging device that has been restricted by the FAC application. The badge information may be entered by swiping a physical badge to the badge reading device 130. Other methods of entering badge information will be known by skilled artisans. In one alternative example embodiment, the imaging device may check its connection with one of master imaging device 105 and backup imaging device 110 prior to displaying a prompt that solicits badge information from the user. If the configured master imaging device 105 is the device used by the user to access one or more device functions, and therefore is the device performing the query, no checking may be performed. If the configured backup imaging device 110 is the querying device, backup imaging device 110 may check its connectivity to master imaging device 105 prior to soliciting badge information. The checking may be performed through a token check from the querying device to at least one of master imaging device 105 and backup imaging device 110 if the devices are part of the system before badge inquiry is permitted.

At 410, the imaging device authenticates the badge information by sending the badge information to master imaging device 105. If master imaging device 105 is available at the time the authentication is requested, the imaging device sends the badge information to master imaging device 105. Alternatively, the badge information may also be sent to backup imaging device 110 if master imaging device 105 is unavailable at the time the authentication is requested. At 415, it is determined if the badge information is in registry 125a. Badge information is present in at least one of the registries if the badge has been registered to the system at a previous time. At 420, if the badge information is in at least one of registries 125a and 125b which indicates that the badge information has been paired with an authorized user credential, the user may be logged in.

At 425, if the badge is not present in the registry, the user may be prompted to enter user credentials to be authenticated using an internal accounts system. Imaging devices in the network may be configured to communicate with an internal account system which contains a list of user accounts that are permitted to access the imaging devices in the system or one or more functions of the imaging devices. For example, the internal account system may contain a list of employees in an organization that are allowed access to the imaging devices belonging to the organization.

In an alternative example embodiment, when a user accesses any of the imaging devices in the network for the first time, such that the user has not been added to the registry at the time of the access, the user may be authenticated using another source such as, for example, an active directory.

At 430, it is determined if the user credentials entered by the user is authorized to access the imaging devices using the internal accounts system communicatively connected with client imaging device 105. The user credentials may be checked against the internal accounts system such as by performing a query on an internal accounts database using the user credentials, or by any other method as will be known by skilled artisans.

If the user credentials are authenticated successfully, the badge ID will be associated to the user credentials (at 435) thereby successfully registering the badge ID as an authorized badge. At 440, the registered badge information is sent to master imaging device 105 for enrolling to registry 125a. If master imaging device 105 is not available, the registered badge information may be sent to backup imaging device 110 instead. The sending of the registered badge information may be performed automatically upon successful association of the badge information and the user credentials, or it may be performed on a predefined schedule.

After the successful authentication and registration of the badge information, the user is now logged in and is now given access to authorized functions of the imaging device (at 420). Once the badge ID has been successfully associated or paired with the user credentials, the badge ID may be used to log into any of the imaging devices in the network without requiring the user to re-register the badge ID to the system.

If at 430, if the user credentials are not found in the internal accounts system, the user may be notified that he/she is not authorized to access the imaging device. The user may be given further instructions such as registering his/her user credentials to the internal accounts system or to the active directory, or to request for authorized user credentials from an administrator.

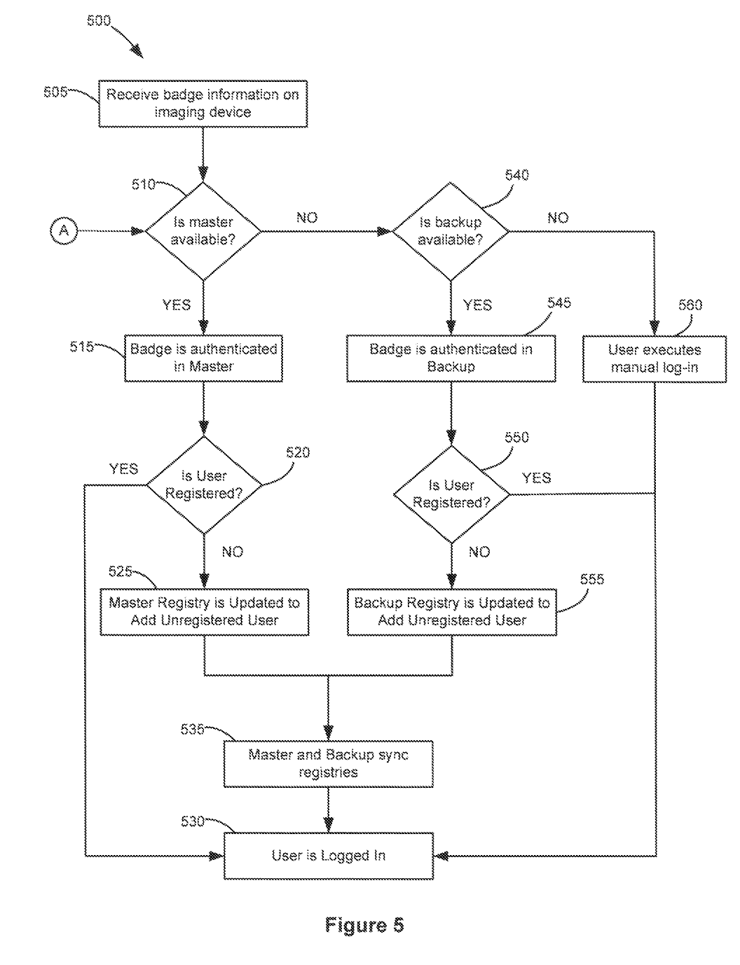

FIG. 5 shows another example method 500 of authenticating a user for operating an imaging device in the network of imaging devices using the example system 100. For illustrative purposes, method 500 is performed in client imaging device 115, but it will be understood that any other imaging device in the network installed with FAC application 120, including the configured master and backup imaging devices 105 and 110, respectively, may perform method 500.

At 505, badge information is received by client imaging device 115. The badge information may be received after a prompt is displayed in interface 135 of client imaging device 115 that prompts the user to enter badge information such as, for example, swiping the badge on badge reading device 130, prior to allowing the user access to FAC-restricted functions in client imaging device 115. The badge information may be received using a badge reading device 130 installed in imaging device 115, or through a manual log-in using a keyboard in the imaging device 115. In an alternative example embodiment, user credentials may be received by client imaging device 115. Examples of user credentials may include a user ID, a username and password, a passcode, and the like. Other forms of user credentials and methods for receiving the user credentials will be known by skilled artisans.

At 510, availability of master imaging device 105 relative to the client imaging device 115 is determined. Availability of master imaging device 105 may be determined by pinging the master imaging device 105 to test whether master imaging device 105 is reachable across the IP network, as well as to measure the round-trip time for messages sent from the client imaging device 115 to the master imaging device 105. Availability of the master imaging device 105 is determined to check if the master imaging device 105 is able to receive the badge information from the client imaging device 115 for authentication.

If master imaging device 105 is not determined to be available, backup imaging device 110 is then checked for availability (at 515). Similar to the determining at 510, determining the availability of backup imaging device 110 may be performed by pinging backup imaging device 110, and other methods of testing whether a device is reachable across a network, as will be known by skilled artisans. If backup imaging device 110 is determined to be available, the authentication will be performed using backup imaging device 110 instead of master imaging device 105.

At 520, if the badge information is sent from client imaging device 115 to one of master imaging device 105 or backup imaging device 110, whichever is available, for determining if the badge information corresponds to a registered user in one of registry 125a and 125b. Registries 125a and 125b may also be used to determine which functions of the client imaging device 115 the user is permitted to access. For example, the badge identification number may be sent to master imaging device 105, and registry 125a, which contains a list of one or more badge identification numbers registered to the system may be checked to determine if the received badge identification information matches a registered badge identification number in registry 125a. The determining may be performed by parsing the entries in registry 125a and searching for an entry matching the received badge information. Alternatively, the determining may be executed by performing a search query on registry 125a if registry 125a is a database.

If the user is determined to be registered, the user is then logged in to client imaging device and is then given permission to access the functions of client imaging device 115 (at 525).

If the badge information is determined by either master imaging device 105 or backup imaging device 115 to be unregistered such that no entry in registry 125a or 125b corresponds to the badge information (at 515), client imaging device 115 may verify the user credentials using the internal account communicatively connected with client imaging device 115 (at 530). Verifying the user credentials using the internal account may be used when the received badge information is not registered in the system which occurs when the badge ID has not yet been paired with an authorized user credential and the pairing entered into registry 125. To verify using the internal account system, the user may be prompted to enter user credentials such as a username and password, and the like. Alternatively, an active directory may be used to verify the user credentials.

If the internal accounts system is unable to verify the received user credentials (at 530), the user is not authorized to access client imaging device 115 and a notification may be displayed in user interface 135 that the user is not authorized in the system and is therefore not given permission to access client imaging device 115 and/or a requested function in client imaging device 115.

However, if at 530, the internal accounts system successfully authenticates the user credentials, information relating to the successful authentication is sent to one of master imaging device 105 and backup imaging device 110 (at 540), whichever device was available at the time the badge information was received. The authenticated information includes the authenticated user credentials and the received badge information. At 545, the authenticated information is then added to registry. When the user credentials are successfully authenticated, the user credentials may be associated with the badge information and added to the registry. Once the badge ID-user credential information is registered, the badge ID may be used to authenticate the user instead of prompting the user to input user credentials when the user requests access to client imaging device 105 at a later time.

At 550, registries 125a and 125b are synced such that the newly added authenticated user information is reflected in both registries. For example, if master imaging device 105 was determined to be available at 510 and the authenticated information was added to registry 125a, registry 125b of backup imaging device 110 may be updated to include the newly added information in registry 125a. Registries 125a and 125b may also be synced to reflect other changes such as, for example, when data is removed, or updated. Data synchronization is performed to establish consistency of the data between registries of master imaging device 105 and backup imaging device 110 such that both devices are able to support badge authentication using updated user data.

In one example embodiment, badge authentication may be blocked in configured client imaging devices in the network while the sync is on-going. When the syncing process between master imaging device 105 and backup imaging device 110 is completed, the imaging devices in the network may resume receiving and authenticating badge information. The sync process may be considered completed when the consistency of the data between registries 125a and 125b is established.

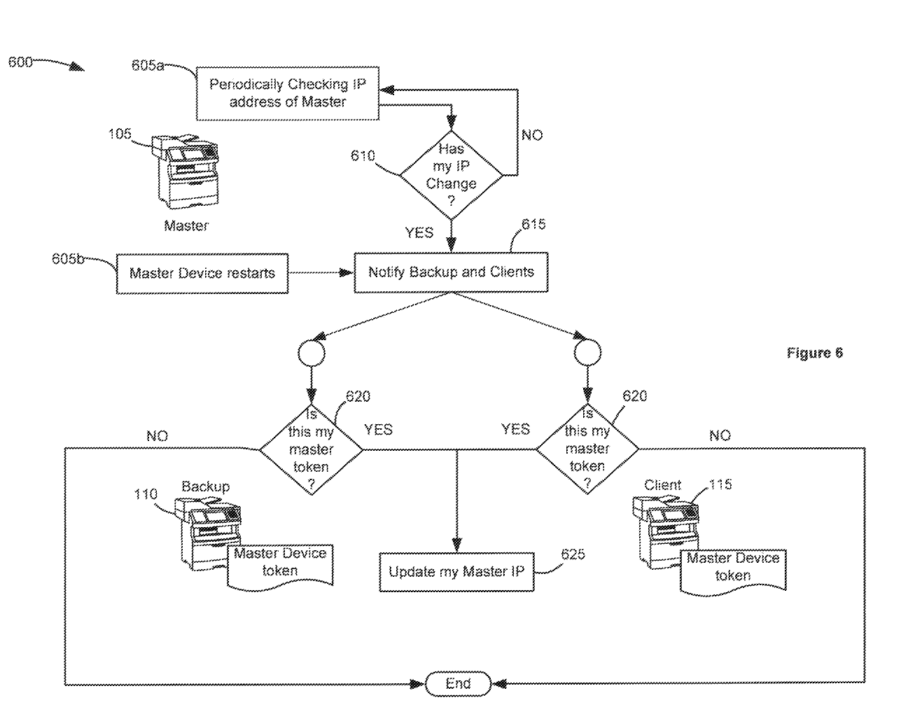

FIG. 6 is an example system 600 and method for managing changes in the imaging device configured to be the master imaging device 105 in the network. The changes may be a change in the network identifier of master imaging device 105 or any change in the network information of master imaging device 105 that may affect communication between master imaging device 105 and other imaging devices in the network. A change in the network identifier of master imaging device 105 may cause miscommunication between master imaging device 105, backup imaging device 110 and one or more registered client imaging devices 115 in the network and an update on the configuration of the imaging devices connected to master imaging device 105 is made to ensure that the imaging devices are able to communicate with the correct master imaging device 105 for authenticating users.

At 605a, master imaging device 105 performs a periodic checking of its network identifier to determine if a change in the network identifier has occurred. For illustrative purposes, the network identifier that is monitored is the IP address of master imaging device 105. It will be understood that the IP address of master imaging device 105 is used as the identifier which other imaging devices in the network use to communicate with master imaging device 105. Other network identifiers or device identifiers that may be used to communicate with master imaging device 105 will be known in the art.

In one example embodiment, the periodic checking of the IP address by master imaging device 105 may be performed using a ping service. The periodic checking may be performed automatically at a predefined schedule as set by an administrator of the network of imaging devices.

At 610, if the ping service determines that the IP address of master imaging device 105 has not changed such that backup imaging device 110 and the one or more registered client imaging devices 115 are still able to communicate with master imaging device 105 using the previously known IP address, master imaging device 105 may continue performing the periodic monitoring or checking of any change in its IP address.

However, if the ping service determines that a change in the previously known IP address of master imaging device 105 has occurred, the backup imaging device 110 and the registered client imaging devices 115 are notified (at 615). Alternatively, if master imaging device 105 restarts (at 605b), the backup imaging device 110 and the registered client imaging devices 115 are notified (at 615).

Notifying the backup and the registered client imaging devices 110 and 115, respectively, includes sending the device token of the master imaging device 105 to the backup imaging device 110 and the registered client imaging devices 115. The device token may be a packet of information that contains data relating to the network identifier of master imaging device 105 such as, for example, MAC address of master imaging device 105 and a random number sequence attached to the MAC address.

At 620, backup imaging device 110 and one or more registered client imaging devices 105 receive the master imaging device token and check if the received device token corresponds to the currently saved master imaging device token that is configured in FAC application 120b of backup imaging device 110. If the received device token which contains the new network information of master imaging device 105 corresponds to the saved master imaging device token in the FAC applications 120b and 120c installed in backup imaging device 110 and the one or more registered client imaging devices 105, backup imaging device 110 and the one or more registered client imaging devices 105 update their settings to now communicate with master imaging device 105 using the received device token. Updating the settings includes replacing the previously saved master device network information with the new network information of the configured master imaging device 105.

If at 620, backup imaging device 110 and the registered client imaging devices 115 determine that the received device token corresponds to the saved master device token, the method ends until master imaging device 105 goes back to periodically checking the network information of master imaging device 105 to monitor any changes (at 605).

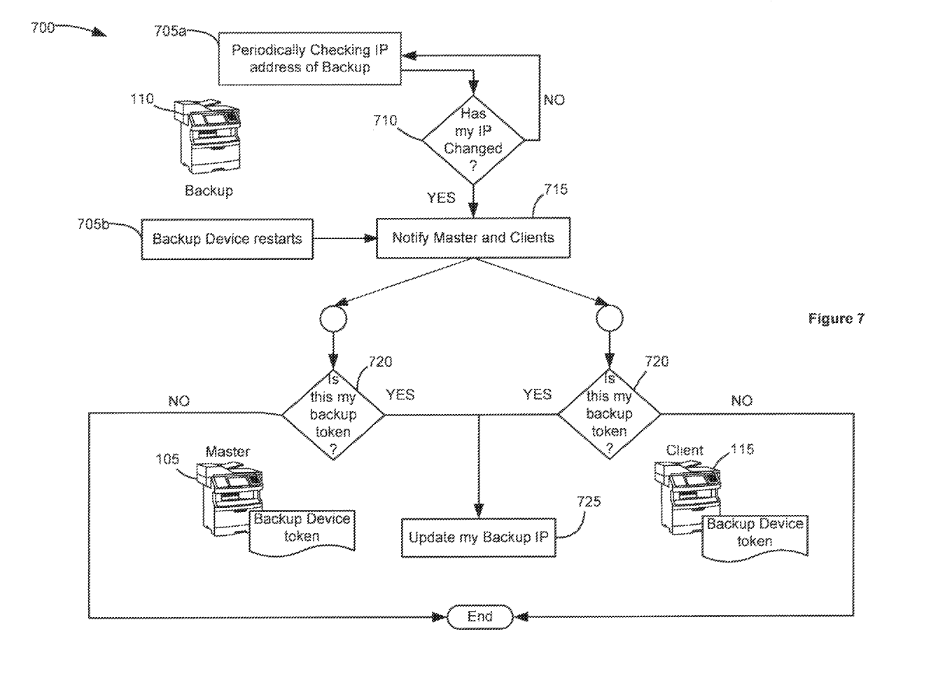

Updating the configuration of other imaging devices in the network when changes are made to the backup imaging device 110 may be performed in a method similar to that of method 400. FIG. 7 shows an example method 700 of updating a master imaging device 105 and one or more registered client imaging device 115 in the network when a change in the network identifier of backup imaging device 110 is detected.

At 705a, a ping service, or another type of service that is used to monitor changes in the network information of backup imaging device 110 is performed. If a change in the device and/or identifier such as, for example, the IP address of backup imaging device 110 is detected at 710, master imaging device 105 and one or more registered client imaging devices 115 in the network may be notified of the change (at 715). Alternatively, if backup imaging device 110 restarts (at 705b), master imaging device 105 and the registered client imaging devices 115 are notified (at 715).

A backup imaging device token which contains the new network information of the backup imaging device 110 is sent to master imaging device 105 and to each of the registered client imaging devices 115 in the network. If at 720, it is determined if master imaging device 105 and the one or more client imaging devices 115 includes an associated backup imaging device network information that matches the new network information received by each of the devices from backup imaging device 110. If the received IP address does not match the configured IP address, master imaging device 105 and the one or more registered client imaging devices 115 are updated to communicate with backup imaging device 110 using the new network information during authentication of the user.

However, if the received network information matches the configured IP address in each of the master imaging device 105 and the one or more registered client imaging device 115, each of the devices are thereby configured with the up-to-date network information of the backup imaging device 110 and should be able to communicate with the correct backup imaging device 110, accordingly. The update process then ends until backup imaging device 110 repeats periodically checking any changes in its network identifier.

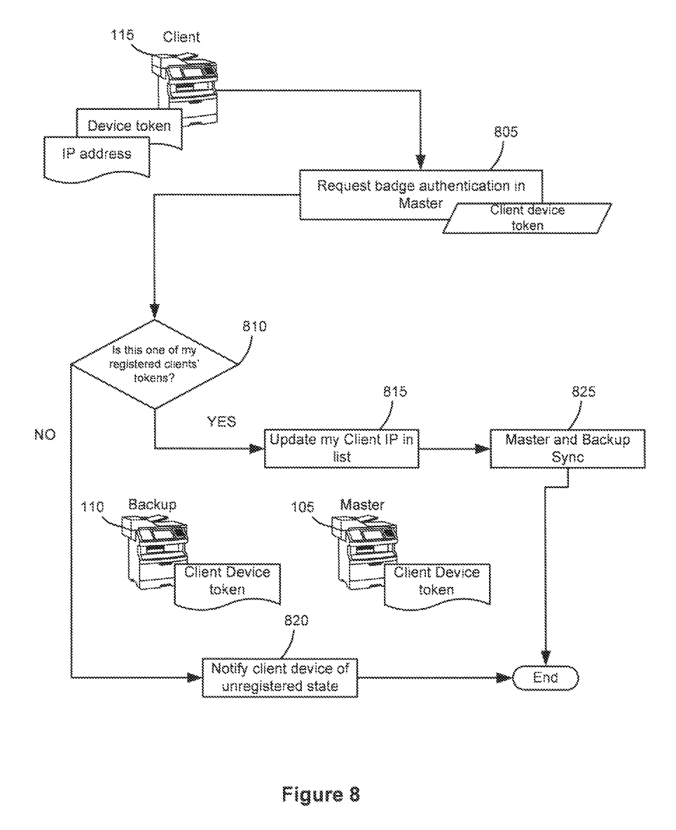

FIG. 8 shows an example system and method for updating the master imaging device 105 and backup imaging device 110 when a change in the network information of client imaging device 115 is detected. The updating of master imaging device 105 and backup imaging device 110 when at least one registered client imaging device 115 has a change in its network identifier is performed when client imaging device 115 requests badge authentication from one of master imaging device 105 and backup imaging device 110 (at 805). Badge authentication is requested from backup imaging device 110 when client imaging device 115 is unable to communicate with master imaging device 105, as discussed above.

At 810, a least one of master imaging device 105 and backup imaging device 110 then determines if the client device token received through the badge authentication request matches a client token registered in at least one of master imaging device 105 and backup imaging device 110. The registered client tokens in registry 125a may be searched line-by-line and checked against the received client device token to determine a match.

At 815, if the received client device token matches a stored or registered client device token in master imaging device 105 and backup imaging device 110, each of master imaging device 105 and backup imaging device 110 then updates their client imaging device configuration with the received client imaging device network information such that each of master imaging device 105 and backup imaging device 110 are able to communicate with the client imaging device 115 using the correct and up-to-date IP address.

However, if the received client device token does not match a stored or registered client imaging device in applications 120a and 120b in master imaging device 105 and backup imaging device 110, respectively, this indicates that the client imaging device 115 that requested the badge authentication is unregistered in registry 125a and a notification is sent back to client imaging device 105 regarding its unregistered state (at 820). The requesting client imaging device 115 may then be prompted to register as a client imaging device of master imaging device 105.

At 825, registries 125a and 125b in master imaging device 105 and backup imaging device 110, respectively, are then synced to reflect the update made in one of registries 125a and 125b.

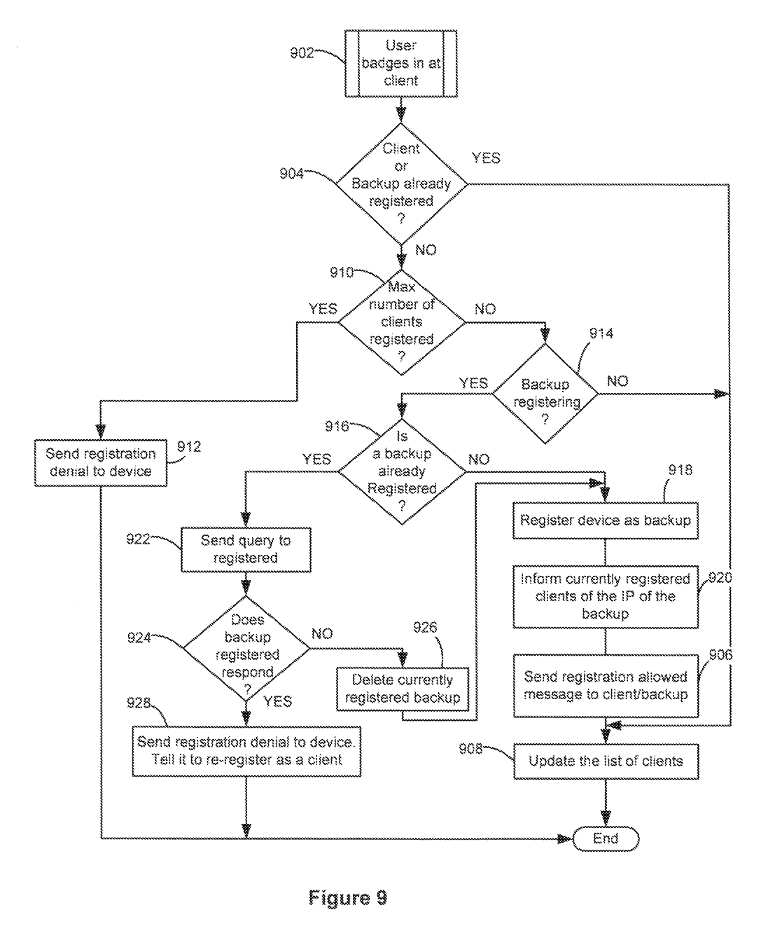

FIG. 9 shows one example embodiment of master imaging device 105 receiving one or more requests for registering a backup imaging device and/or one or more client imaging devices to the system. Registering a client imaging device may be performed to associate the imaging device as a client imaging device in the network that master imaging device 105 may perform badge validation processing for. Registering a backup imaging device may be performed to configure an imaging device to execute functions in lieu of master imaging device 105 when the configured master imaging device 105 is down.

At 902, master imaging device 105 receives a request for registering an imaging device to be one of a backup imaging device or a client imaging device. At 904, it is determined if the imaging device has been registered for at least one of the roles. The determining may be performed by checking if a network identifier of the requesting imaging device is in the list of imaging devices previously registered as one of backup imaging device or a client imaging device in master imaging device 105. If it is determined that the imaging device has been registered, a message may be sent to the requesting device indicating that the registration has been successfully performed (at 906) and the list of clients may be updated to include the requesting imaging device (at 908).

If at 904, it is determined that the requesting imaging device has not been previously registered, master imaging device 105 identifies if the maximum number of registered clients has been reached (at 910). An administrator of system 100 may set a maximum number of imaging devices that can register as client imaging devices in the network. Alternatively, a maximum number of registered client imaging devices may not be set.

If the maximum number of registered clients has been reached, the registration is denied and a registration denial notice may be sent to the registering device (at 912).

If the maximum number of registered clients has not been reached, it is determined if a backup imaging device is registering (at 914).

If the imaging device is attempting to register to the system as a backup imaging device, master imaging device 105 checks if a registered backup imaging device exists in the system (at 916) and if the system currently has no registered backup imaging device, the registering device is enrolled as a backup imaging device and will be associated with master imaging device 105 and one or more registered client imaging devices (at 918). At 920, currently registered client imaging devices may be informed about the network identifier of the newly-registered backup imaging device 110. The IP address of the newly-registered backup imaging device 110 may be sent to the registered client imaging devices such that the currently registered client imaging devices may update their FAC application 120 to communicate with the newly-registered backup imaging device 110 for badge validation purposes when master imaging device 105 is down. A successful registration notice may then be sent to the registering imaging device (at 906).

If at 916, if it is determined that a backup imaging device is currently registered to the system, a query is sent to the currently-registered backup imaging device (at 922) to determine if the currently-registered backup imaging device 110 is communicatively connected to master imaging device 105. The query may be a ping, or any other query that solicits a feedback from backup imaging device 110, as will be known in the art. At 924, if the currently-registered backup imaging device does not respond which indicates that the currently-registered backup may be unavailable, the currently-registered backup imaging device may be deleted from the system, and the registering device replaces it as the current and newly-registered backup imaging device (at 918). If at 924, the currently-registered backup imaging device responds, a message indicating denial of registration is sent to the registering device (at 928) informing the user that registration by the registering device to master imaging device 105 has failed.

When master imaging device 105 is initialized such as, for example, when master imaging device 105 is powered on or settings of master imaging device 105 is updated, and the like, FAC application 120a may be initialized and a query may be sent to each of the registered backup imaging device 110 and the one or more registered client imaging devices. The query includes the IP address of master imaging device 105. Master imaging device 105 then waits for a response from each of the registered devices which may indicate that each of the registered devices is communicatively connected to master imaging device 105. If the sending of the query is performed when master imaging device 105 was unavailable for badge processing, the query may inform each of the registered devices that master imaging device 105 is once again available to be the primary source of badge validation processing instead of backup imaging device 110.

Backup imaging device 110 may also register with the master imaging device 105 to verify if master imaging device 105 is available for badge processing and whether backup imaging device 110 may assume the role as backup or as a temporary master imaging device while master imaging device 105 is down. When an imaging device is initialized such as, for example, when the settings of the imaging device are updated to configure the imaging device to become the backup imaging device, imaging device makes an attempt to register with master imaging device 105. Initializing imaging device includes initializing FAC application 120 installed in the device. The currently-registering imaging device may proceed as the configured backup imaging device of the network pending registration with master imaging device 105.

The currently-registering imaging device sends registration message to master imaging device 105. The registration message may include the role requested by the imaging device and a network identifier of the currently-registering imaging device such as its IP address. If response is not received from master imaging device 105, master imaging device 105 may be marked as unavailable and the currently-registering imaging device may assume the master's role.

If response is received from master imaging device 105, which indicates that master imaging device is available, the currently-registering imaging device checks if the response of the master imaging device 105 to the registration request is accepted or denied. If the registration is accepted, the network identifier of master imaging device 105 is recorded by the currently-registering imaging device, master imaging device 105 may be marked as available and the currently-registering imaging device is now the registered backup imaging device 110 for the system. The newly-registered backup imaging device 110 is now able to take on the functions of master imaging device 105 if master imaging device 105 is unavailable.

If the response received from master imaging device 105 denies the registration of the currently-registering imaging device as the backup device, which may occur if there is a currently registered backup imaging device, the currently-registering imaging device may record the network identifies of master and backup imaging devices and may register as client imaging device 110 instead of backup imaging device.

One or more imaging devices in the network may also register with master imaging device 105 as a client imaging device. The registering may be performed when settings in FAC application 120 installed in the imaging device are updated to take on the role of a client imaging device in the network. The registering may also be performed upon FAC application 120 start-up. The currently-registering imaging device may send a registration message to master imaging device, the message including the desired role (e.g. client imaging device), and its network identifier such as, for example, its IP address or its token. If response is not received from master imaging device 105, after at least one retry to establish communication, master imaging device 105 is marked unavailable and the registration message may be sent to the backup imaging device 110 instead. If response is not received from backup imaging device 110, backup imaging device 110 is marked unavailable and currently-registering imaging device may not be able to accept badge-in requests until it is successfully registered with at least one of master imaging device 105 and backup imaging device 110.

If response is received from at least one of master imaging device 105 and backup imaging device 110, and the response indicates acceptance of the registration, the currently-registering imaging device records IP of master and backup imaging device 105 and 110, marks them as available and proceed as a registered client imaging device 115. A registered client imaging device 115 is now able to accept badge-in requests from users.

If the response indicates a denied registration, a message of the registration result may be displayed in user interface 135 of currently-registering imaging device and the currently-registering imaging device is unable to receive badge-in requests from users.

The foregoing illustrates various aspects of the invention. It is not intended to be exhaustive. Rather, it is chosen to provide the best illustration of the principles of the invention and its practical application to enable one of ordinary skill in the art to utilize the invention, including its various modifications that naturally follow. All modifications and variations are contemplated within the scope of the invention as determined by the appended claims. Relatively apparent modifications include combining one or more features of various embodiments with features of other embodiments.

1. In a network of imaging devices, a method for authenticating a user for operating one of the imaging devices from the network without using an authentication server, the method comprising:
configuring a first imaging device from the network of imaging devices to store a registry of users authorized to access the imaging device;
receiving log-in information from the user at the imaging device;
sending the log-in information from the imaging device to the first imaging device for determining if the log-in information corresponds to an authorized user in the registry;
receiving a result of the determining if the log-in information corresponds to the authorized user in the registry; and
if the result of the determining indicates that the log-in information corresponds to the authorized user in the registry, providing the user access to one or more functions of the imaging device.

2. The method of claim 1, further comprising, configuring a second imaging device in the network of imaging devices to store a copy of the registry of users authorized to access the imaging device.

3. The method of claim 2, further comprising determining if the imaging device is able to send the log-in information to the first imaging device and if the imaging device is not able to send the log-in information to the first imaging device, sending the log-in information, from the imaging device, to the second imaging device.

4. The method of claim 3, further comprising determining at the second imaging device if the log-in information corresponds to an authorized user using the copy of the registry and receiving a result of the determining from the second imaging device at the imaging device.

5. The method of claim 3, further comprising, determining if the imaging device is able to send the log-in information to the second imaging device, and if the imaging device is not able to send the log-in information to the second imaging device, allowing the user to manually enter the log-in information in the imaging device.

6. The method of claim 2, further comprising exporting the registry of users from the first imaging device for use by another device. (another master of another network)

7. The method of claim 1, further comprising importing another registry of users to the first imaging device for updating the stored registry of users.

8. The method of claim 1, wherein the receiving the result of the determining at the imaging device includes receiving the one or more functions of the imaging device that the user is authorized to access in the imaging device.

9. The method of claim 1, wherein the configuring the first imaging device in the network of imaging devices to store the registry of users authorized to access the imaging device includes installing an application on the first imaging device containing the registry and one or more functions for maintaining the registry.

10. A system for authenticating a user for accessing one or more functions of a first imaging device without an authentication server, the first imaging device connected to a network of imaging devices, comprising:
the first imaging device from the network of imaging devices configured to receive user credentials from the user; and
a second imaging device from the network of imaging devices installed with an application for use in authenticating a user for accessing the one or more functions of the first imaging device, the second imaging device configured to:
receive the user credentials from the first imaging device;
determine using the application if the user credentials corresponds to a user authorized to access the first imaging device; and
upon positive determination, send an indication to the first imaging device that the user is authorized to access the one or more functions of the first imaging device;
wherein the first imaging device provides the user access to one or more functions of the first imaging device upon receiving the indication from the second imaging device.

11. The system of claim 10, wherein the application installed on the second imaging device includes a registry of one or more users authorized to access an imaging device from the network of imaging devices.

12. The system of claim 11, further comprising a third imaging device from the network of imaging devices installed with an application for use in authenticating the user prior to the user accessing the one or more functions of the first imaging device if the second imaging device is unable to receive the user credentials from the first imaging device.

13. The system of claim 12, wherein the application installed on the third imaging device includes a copy of the registry of the one or more users authorized to access an imaging device from the network of imaging devices.

14. The system of claim 13, wherein the registry in the second imaging device and the copy of the registry in the third imaging device are synced at a pre-defined schedule.

15. The system of claim 14, wherein the second imaging device is configured to suspend the determining if the user credentials correspond to the user authorized to access the first imaging device until after the registry in the second imaging device and the copy of the registry in the third imaging device are synced.

16. The system of claim 10, wherein the second imaging device is further configured to determine if the user credentials correspond to an existing user in the registry.

17. The system of claim 16, wherein if the second imaging device determines that the user credentials does not correspond to an existing user in the registry, updating the registry by adding a new user to the registry corresponding to the user credentials.

18. A method for authenticating a user prior to accessing one or more functions of at least one imaging device from a network of imaging devices without use of a dedicated authentication server, comprising:
configuring a first imaging device in the network of imaging devices to function as a master imaging device by storing a registry of users authorized to access one or more of the imaging devices from the network of imaging devices in the first imaging device;
configuring a second imaging device to function as a backup imaging device in the network of imaging devices by storing a copy of the registry of users in the second imaging device;
receiving at the at least one imaging device from the network of imaging devices log-in information from the user;
determining by the at least one imaging device if the master imaging device is able to receive the log-in information to be authenticated using the registry;
upon positive determination, sending the log-in information from the at least one imaging device to the master imaging device to be authenticated using the registry;
upon negative determination, sending the log-in information from the at least one imaging device to the backup imaging device to be authenticated using the copy of the registry;
receiving by the at least one imaging device a result of the authentication of the log-in information from one of the master and the backup imaging devices; and
if the result of the determining indicates that the log-in information corresponds to a user authorized to access the at least one imaging device, providing the user access to one or more functions of the at least one imaging device.

19. The method of claim 18, further comprising configuring the at least one imaging device in the network of imaging devices to communicate with the master imaging device by storing, in the at least one imaging device, a network identifier of the master imaging device.

20. The method of claim 19, further comprising determining, by the master imaging device, a change in the network identifier of the master imaging device and upon positive determination, notifying the at least one imaging device regarding the change in the network identifier.

21. The method of claim 20, further comprising updating the stored network identifier in the at least one imaging device to reflect the change in the network identifier of the master imaging device.

22. The method of claim 18, wherein the configuring the second imaging device function as the backup imaging device by storing the copy of the registry of users includes updating the copy of the registry in the second imaging device to match the registry in the master imaging device at a predefined schedule.

23. The method of claim 21, further comprising configuring another imaging device from the network of imaging devices to function as the master imaging device by storing the registry of users in the another imaging device instead of in the first imaging device.

24. The method of claim 23, wherein the configuring the another imaging device to function as the master imaging device further includes deleting the registry of users from the first imaging device.

25. The method of claim 18, further comprising migrating the registry of users from the master imaging device to another device in the network of imaging devices.

26. The method of claim 18, further comprising recording in the backup imaging device any changes made on the copy of the registry while the master imaging device is determined to be unable to receive the log-in information from the at least one imaging device.

27. The method of claim 26, further comprising if the master imaging device is determined to be able to receive the log-in information from the at least one imaging device after the log-in information has been sent to the backup imaging device, syncing the registry of master imaging device with the copy of the registry of the backup imaging device based on the changes recorded in the backup imaging device.

28. The method of claim 18, further comprising upon initializing the master imaging device, the master imaging device communicates with registered one or more imaging devices thereby allowing the one or more registered imaging devices to connect to the master imaging device as a primary source of the registry of users.

29. The method of claim 18, further comprising upon initializing the backup imaging device, the backup imaging device communicates with the master imaging device and if the master imaging device is unreachable, the backup imaging device assumes role of the master imaging device and notifies one or more registered imaging devices to communicate with the backup imaging device for authenticating the user.
